(19) United States
(12) Patent Application Publication
(10) Pub. No.: US 2010/0097902 A1
(43) Pub. Date: Apr. 22, 2010

(54) TRACK WRITING WITH RADIAL ERROR OFFSET CORRECTION

(75) Inventors: Gary Maul, Eindhoven (NL); Edwin Johannes Maria Janssen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,321

(22) PCT Filed: Jun. 26, 2006
(86) PCT No.: PCT/IB06/52098

§ 371 Date: Dec. 20, 2007

(30) Foreign Application Priority Data
Jun. 30, 2005 (EP) 05105903.8
Aug. 1, 2005 (EP) 05107090.2

(51) Int. Cl. G11B 7/00

(52) U.S. Cl. 369/44.39; G9B/7.009

(57) ABSTRACT

The present invention relates to a method and apparatus for writing data on a record carrier (1) by using a radiation beam, wherein at least one of a writing power and an asymmetry of data written on the record carrier (1) is determined and a radial error offset, applied to the radiation beam with respect to a writing track of the record carrier (1), is controlled in response to at least one of the determined writing power and the determined asymmetry. Thereby, the radial error offset can be linked to at least one of the applied writing power and the obtained asymmetry of the written data, and can thus be altered before or during writing to maintain reasonable tracking in cases where writing is done on record carriers with variable radial error offset.

The present invention relates to a writing method and apparatus for writing data on a record carrier, such as an optical disc, by using a radiation beam. In particular, the present invention relates to write control functionality in an optical disc drive device.

To read or write on a record carrier or data storage medium, e.g. an optical data storage medium such as a CD (Compact Disc) or DVD (Digital Versatile Disc), a radiation beam, e.g. a radiation beam, has to be focused onto the storage medium. The effective optical distance from the focusing lens to the recording surface has to be kept constant. To achieve this, the focusing lens must be brought in proximity to the recording surface, for example by means of an actuator carrying the focusing lens. This actuator is part of a servo loop and is driven by currents which are derived from a focus error signal (FES) which in turn is derived from light reflected at the storage medium, e.g., optical disc. At some initial time, the servo loop is closed and, from then on, the radiation beam is kept in focus on the storage medium at all times, following bending (flutter) and thickness variations (both of these give rise to so-called axial run-out) and compensating for accelerated motion of parts of the system due to for example a mechanical shock.

The correct amount of laser power needed to write a recordable or re-writeable disc is variable and depends on both the individual recorder, disc and sometimes even the specific location on the disc. Due to their physical makeup, the various types of dyes used in such discs have different sized power windows and therefore require different amounts of laser power for proper recording. Power window refers to the range of laser energy which will properly form the correct size marks on a disc, which not only can vary between the type of dye used but is also dependent upon the speed at which the disc is being recorded. Too much power will create oversized marks which can interfere with each other physically and practically when being read. Too little power will produce undersized marks and the reduced signal levels during playback can, in extreme instances, cause read failure.

Consequently, before starting, all recorders perform an initial Optimum Power Calibration (OPC) procedure to determine the best writing laser power setting for each disc and recorder combination. The OPC process begins with the recorder retrieving an initial Recommended Optimum Recording Power estimate value for a specific writing condition from the Absolute Time In Pregroove (ATIP) information encoded in the Lead-In Area of the disc. An ATIP section is however only present on recordable CD's (e.g. CD-R/RW media) and can contain media manufacturer name, disc type and additional information. DVD and BD (Blu-ray Disc) media have aux_bytes which will then be used. Using this setting as a starting point the recorder steps through higher and lower laser power settings while writing test information in a special reserved space of the disc called the Power Calibration Area (PCA), located before the disc's Lead In Area, the PCA is located where the OPC test is performed to find the optimum laser power setting for the writing laser and write strategy.

In a so-called “Walking” OPC scheme, after writing the test marks at the different laser powers the recorder reads them back and looks for differences between the lengths of marks and lands. These difference between the lengths of marks and lands are called “asymmetry” or “Beta”. A negative beta means that, on average, the marks are underpowered (too short) and a positive beta means that they are overpowered (too long). To be broadly compatible with the various available types of media, recorders traditionally use a beta of +4% (as suggested for example in the Orange Book Part H specification for CD media), though some units now have multiple target betas and write strategies (the latest version of the Orange Book actually mandates the use of specific target betas and write strategies). The recorder then determines what setting achieved the desired beta target and establishes that as the recording power for the disc.

During the initial OPC procedure the recorder also monitors the reflected light coming back from the disc while the marks are forming and stores that information. After determining what power setting yields the desired beta the recorder retrieves the reflected signal that is associated with it, establishes a mark formation signature, and saves it in its memory. During recording the system monitors the marks as they form on the disc using the reflected light and compares these signals against the signature established during the initial OPC procedure. Laser power is then adjusted on-the-fly throughout the writing process to maintain this optimum condition.

However, writing on recordable disc media, such as DVD+R media, is extremely susceptible to small variations in the drive and media, so that any improvements in the writing performance, however small, are very important in creating more or greater margins in the system.

FIG. 2 shows a schematic structure of a normal double-layer DVD+R disc, where the laser light used for writing is entered through the upper surface of an upper substrate 22. Such double-layer discs require two recording layers 24, 30 and two reflector layers 26, 32. As shown in FIG. 2, the layer structure comprises the upper substrate 22 with grooves, a first recording layer (L0) 24, a semi-transparent reflector layer 26, an intermediate spacer layer 28 with grooves, a second recording layer 30, a reflector layer 32, and a dummy substrate 34.

In contrast to this “layered system” in which discs are manufactured by stacking all the layers on top of a substrate, a new so-called “inverted stack system” or “inverse stack model” has been developed, where a first disc comprising the above upper substrate 22 and the above semi-transparent reflector layer 26 and a second disc comprising the above second recording layer 30 and a lower substrate are first separately manufactured, and then adhered together to obtain a single double-layer disc.

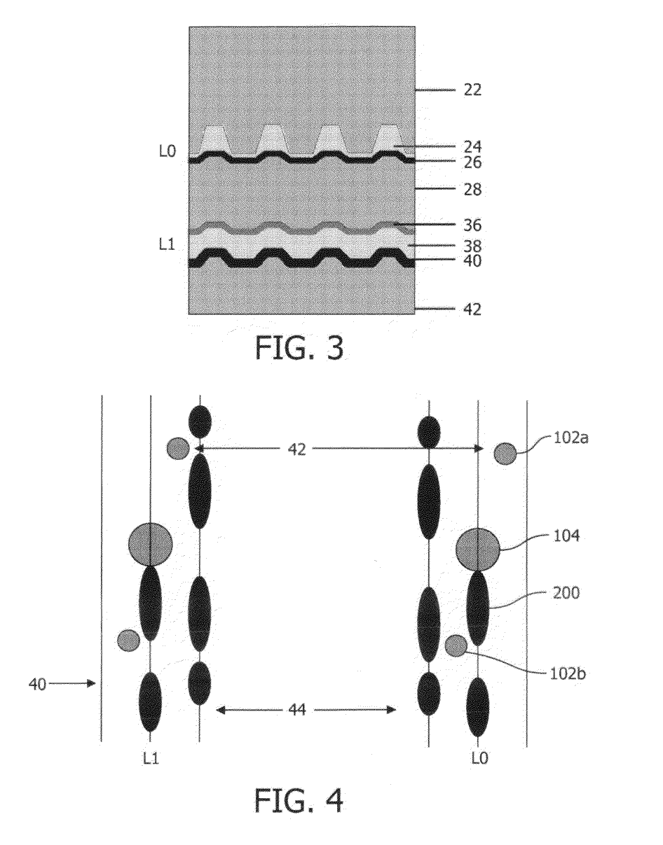

FIG. 3 shows a schematic structure of a double-layer DVD+R disc according to the inverted stack system, where the laser light used for writing is also entered through the upper surface of the upper substrate 22. Here, the layer structure comprises the upper substrate 22 with grooves, the first recording layer (L0) 24, the semi-transparent reflector layer 26, and the intermediate spacer layer 28 which however does not have any grooves. Contrary to the normal double-layer disc, this special double-layer disc comprises an additional protective layer 36 followed by the second recording layer 38, the reflector layer 40, and a lower substrate 42 with grooves.

Some advantages of this inverted stack system are that manufacturing of the first and second discs can be done in parallel up to the adhesion process, which allows high volume production, and that a regular metal stamper can be used with high durability at lower costs. Moreover, since the first and second discs can be manufactured independently and adhered at the end of the process, the testing precision can be dramatically improved.

On the other hand, the wobble (spiral grooves), which is required for each recording layer, is created in the first disc between the upper substrate 22 and the first recording layer (L0) 24 in the same way as a single-layer disc. In the second disc, on the other hand, the wobble must be created between the reflective layer 40 and the lower substrate 42. This results in different structures for the first and second discs and requires advanced design technology. In addition, the wobble in the second disc is located in the farthest point from the pickup unit which generates the writing laser, so that the second disc requires a sharper and more precise groove formation and a high-precision stamper.

Known radial tracking error detection methods include push-pull radial tracking, in which a signal difference between two pupil halves are measured on separate detectors; central aperture radial tracking, in which the radiation beam is split into three beams by a diffraction grating, and the outer satellite spots are set a quarter track pitch off the main central spot and the difference of their signals is used to generate the tracking error signal; and three-spots push-pull radial tracking, in which the radiation beam is split into three beams by a diffraction grating and a difference between the push-pull signals of the main spot and the satellite spots is used as a tracking error signal. The three-spots push-pull radial tracking has an advantage over the one-spot push-pull systems in that systematic errors and asymmetric errors may be compensated for automatically. The three-spot push-pull radial tracking system has an advantage of the central aperture radial tracking in a recording device in that a significantly higher signal-to-noise ratio can be achieved, in particular when scanning a blank optical disc.

The two recording layers of double-layer discs can be written by a parallel track path (PTP) or opposite track path (OTP). In PTP discs both layers are written from the inside of the disc to the outside, whereas in an OTP disc the outer layer is written from the inside to out, and then back in for the inner layer. This allows the drive to read both layers almost continuously, with only a short break to refocus the pickup lens. This is especially useful for DVD movies, where long play time without interruption is needed.

FIG. 4 shows on its right portion a schematic representation of three adjacent tracks of the first recording layer L0 of an OTP disc, while the left portion of FIG. 4 shows a schematic representation of three adjacent tracks of the second recording layer L1 of the OTP disc. In both cases, the radiation beam is burning or writing the middle track with its main spot 104. The two smaller spots 102a, 102b represent the satellite spots. The three tracks on the left portion of FIG. 4 show the situation when the second recording layer L1 is being written or recorded, while the three tracks on the right portion of FIG. 4 show the situation when the first recording layer L0 is being written or recorded. The writing operation proceeds in the upward direction of FIG. 4, so that the oval-shaped black areas 200 represent written spots or pits. The lower portion of FIG. 4 thus represents a written area 44 and the upper area of FIG. 4 represents a leading area 42 with respect to the writing direction. The most outer vertical line 40 on the left side of FIG. 4 represents a non-written or blank track. A similar blank track is shown on the right side of FIG. 4.

Thus, when the first recording layer L0 is written, the leading satellite spot 102a sees two blank tracks and the trailing satellite spot 102b sees two written tracks. In contrast thereto, when the second recording layer L1 is written, the leading satellite spot on the left portion of FIG. 4 now sees one written track on one side only and one blank track on the other. The same applies to the trailing satellite spot on the left portion of FIG. 4. However, this difference creates a slight radial error offset.

In the normal double-layer disc structure of FIG. 2, this radial error offset is small and relatively invariable. However, in special double-layer discs, such as the above inverted stack system or P2 substrate discs, it has been found that this radial error offset is variable and may thus influence reliability of the tracking operation. Writing may thus not be performed exactly on the track.

It is therefore an object of the present invention to provide a writing apparatus and method, by means of which reasonable tracking can be maintained during writing on OTP discs with variable radial error offset.

This object is achieved by a writing apparatus as claimed in claim 1 and by a writing method as claimed in claim 9.

Accordingly, the radial error offset is linked to at least one of the applied writing power and the obtained asymmetry of the written data, and can thus be altered before or during writing to maintain reasonable tracking in cases where writing is done on record carriers with variable radial error offset. Due to the improved writing performance, system margins can be improved.

The radial error offset may be changed during a writing operation to thereby provide an adaptive offset control if writing power or data asymmetry vary during the writing operation. Furthermore, the asymmetry (or Beta) may be determined during an optimum power control procedure, so that no additional processing step or means is required for the proposed solution.

In particular, the radial error offset may be changed (increased or decreased) if at least one of the determined writing power and the determined asymmetry changes (increases or decreases). As a specific example, the radial error offset may be changed in a stepwise manner within a predetermined range of at least one of the determined writing power and the determined asymmetry, wherein the radial error offset can be changed by a predetermined first amount for every change of at least one of the determined writing power and the determined asymmetry by a respective predetermined second amount. Thereby, the offset control procedure can be kept simple and does not require any look-up tables or other memories for storing specific non-linear relationships or control values.

The offset control may be adapted to keep the radial error offset constant if at least one of the determined writing power and the determined asymmetry exceeds a respective predetermined first threshold value. Additionally, the offset control may be adapted to keep constant the radial error offset if at least one of the determined writing power and the determined asymmetry is lower than a respective predetermined second threshold value. This provides the advantage that the radial error offset control is limited to a predetermined range where reasonable tracking cannot be ensured without offset control.

If write control of the writing apparatus, e.g. disc recorder or player, is performed by means of a computer device and based on a software program or software routine, the proposed offset control or offset correction can be implemented as a computer program product comprising code means for producing the steps of method claim 9 when run on the computer device. The computer program product may be stored on a computer-readable medium, such as an optical or magnetic disc.

Further advantageous modifications are defined in the dependent claims.

The present invention will now be described on the basis of the preferred embodiments with reference to the accompanying drawings, in which:

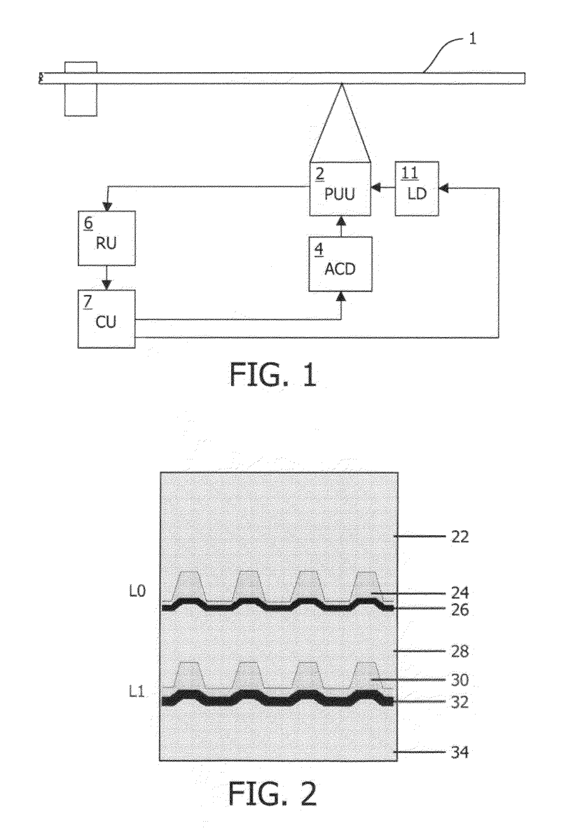

FIG. 1 shows a schematic block diagram of a writing apparatus according to the preferred embodiment,

FIG. 2 shows a layer structure of a normal recordable double-layer disc;

FIG. 3 shows a layer structure of a recordable double-layer disc according to the inverted stack system;

FIG. 4 shows schematic diagrams of a three-spot push-pull tracking operation in two recording layers of an OTP-type disc;

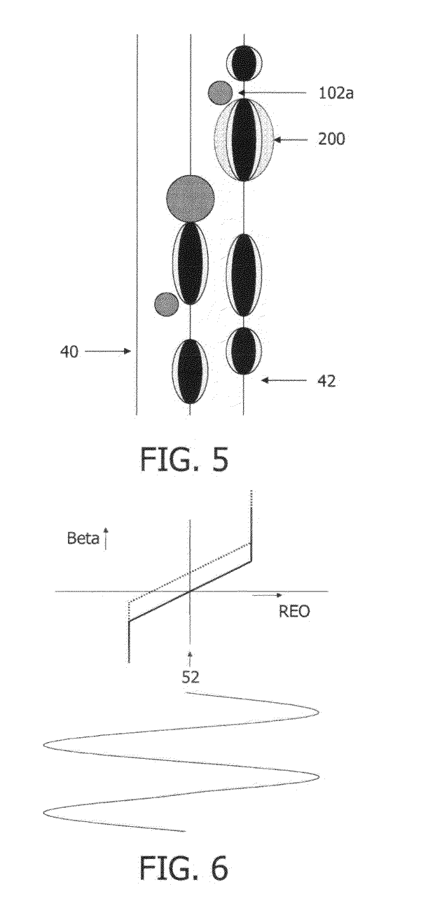

FIG. 5 shows a schematic diagram of the three-spot push-pull tracking operation with possible spot growth; and

FIG. 6 shows a characteristic diagram indicating data asymmetry vs. radial error offset.

The preferred embodiments will now be described on the basis of an optical disc drive as shown in FIG. 1.

FIG. 1 shows those elements of the optical disc drive, which are involved in a write control operation of the optical disc drive, in which an offset control scheme according to the preferred embodiment can be implemented. The optical disc drive comprises an optical pickup unit 2 which can be moved by a feed motor (not shown) in the radial direction of an optical disc 1 on which a generated radiation beam with its main beam and two satellite beams is focused.

It is to be noted here that any suitable mechanism for adjusting the focus of an optical head of the pickup unit 2 based on a focus controller signal can be applied in the preferred embodiment. It is also to be noted that any suitable focus error signal may be used to control the focus on the optical disk.

Additionally, the optical disc drive comprises an actuator (not shown) disposed in the pickup unit 2 and used for supporting an optical lens of the pickup unit 2. This actuator is driven by an actuator driver 4. The actuator driver 4 which comprises a focus controller and a tracking controller drives the actuator through feeding back a signal for moving the object lens of the pickup unit 2 in the direction of the optical axis and in the tracking direction for servo control. A signal which is received from the pickup unit 2 is processed in a read unit 6.

According to the preferred embodiment, an offset control unit 7 is provided which generates a control signal for controlling a radial error offset to be applied by the actuator driver 4 during a writing operation. The offset control is performed in a manner so that it is power-related. This can be achieved by linking the radial error offset to at least one of writing power and beta or asymmetry of the written data. The values of the writing power and the asymmetry can be obtained from the OPC procedure which may be controlled by the offset control unit 7 or a separate write control unit or function.

To achieve this, the offset control unit 7 calculates the asymmetry value and an amplitude of the read signal in a conventional manner based on e.g. top level, bottom level and DC level of an A/D converted read signal obtained from the read unit 6. Additionally, the offset control unit 7 may provide a conventional offset control function for focus control, where the focus offset is gradually changed from an initial value to a final value by a predetermined step through inputting a control signal to the actuator driver 4. Moreover, the offset control unit 7 calculates sets the writing power of the laser provided in the pickup unit 2 to a predetermined value and then records or writes pre-test data while changing the focus offset gradually. Then, the offset control unit 7 calculates the focus offset from a focus error signal received from the read unit 6 and executes an OPC based on the focus offset determined from the reading of the pre-test data. Thus, both values of the writing power and the asymmetry are available at the offset control unit 7 so as to provide a link between at least one of these values and the radial error offset.

In particular, the proposed radial error offset control or correction is made in such a manner that the radial error offset is increased with increasing writing power. Similarly, the radial error offset can be increased with increasing amount of the calculated data asymmetry. The two types of control may be formed in parallel, selectively or separately. Of course, the radial error offset control may as well be restricted to only one of the above two types, e.g. linked either to the writing power or to the data asymmetry.

In a selective approach of the above control types, the asymmetry (or Beta) may be used for radial error offset control and may be derived from the correction of the asymmetry by the OPC procedure, especially if a change is detected in the asymmetry value but not in the power value.

In the power-linked offset control, a predetermined power range (e.g. relative or absolute value 50 to 100) may be defined, within which radial error offset control is performed e.g. in a stepwise manner (e.g. by adding an absolute or relative value of 0.1 to the radial error offset per each 10 units of power value). Above a first threshold value (e.g. 100) and below a second threshold value (e.g. 50) the radial error offset value is no longer changed and thus maintained or kept constant, at least during writing. Of course, the same stepwise approach with limiting first and second threshold values may be applied in case of the additional or alternative asymmetry-linked offset control.

In both offset control types, the offset control within the operating range may be based on a linear or non-linear relationship between radial error offset value and asymmetry value and/or power value.

FIG. 5 shows a schematic diagram of a three-spot push-pull tracking operation with possible spot growth. As can be gathered from FIG. 5, the written spots or pits 200 can grow in the radial direction of the disc 1 until the radial error offset increases to a maximum point where the left half of the leading satellite spot 102a starts to “see” the spots as well. This leads to a saturation effect of the detrimental effect of variable offset to be prevented by the proposed radial error offset control or correction function. The above saturation effect is also the reason for the limited operation range of the proposed radial error offset control.

FIG. 6 shows a characteristic diagram indicating two sample curves defining the relation between data asymmetry (Beta) and radial error offset (REO). As shown in FIG. 6, the radial error offset is linked to the Beta value or asymmetry value by a linear relationship which is limited to a predetermined Beta range beyond with the radial error offset is no longer increased. The continuous line defines a relationship with a zero value or predetermined start value of the radial error offset at a zero Beta value, while the dotted line defines a relationship where the zero value or predetermined start value of the radial error offset is applied when the Beat value has reached a predetermined value. The sinusoidal curve at the bottom of FIG. 6 indicates the push-pull control signal used for radial tracking.

In summary, a method and apparatus for writing data on a record carrier by using a radiation beam has been described, wherein at least one of a writing power and an asymmetry of data written on the record carrier is determined and a radial error offset, applied to the radiation beam with respect to a writing track of the record carrier 1, is controlled in response to at least one of the determined writing power and the determined asymmetry. Thereby, the radial error offset can be linked to at least one of the applied writing power and the obtained asymmetry of the written data, and can thus be altered before or during writing to maintain reasonable tracking in cases where writing is done on record carriers with variable radial error offset.

It is to be noted that the description of the invention shall not be seen as limitation to the invention. Basically, the inventive principle of the present invention may be applied to any optical disc or other record carrier where a power-related variable radial error offset is observed. Specifically, the invention can be applied to any disc writing system and is intended to cover any kind of control which links the radial error offset to at least one of writing power and data asymmetry. The preferred embodiment may thus vary within the scope of the attached claims.

Finally but yet importantly, it is noted that the term “comprises” or “comprising” when used in the specification including the claims is intended to specify the presence of stated features, means, steps or components, but does not exclude the presence or addition of one or more other features, means, steps, components or group thereof. Further, the word “a” or “an” preceding an element in a claim does not exclude the presence of a plurality of such elements. Moreover, any reference sign does not limit the scope of the claims.

1. A writing apparatus for writing data on a record carrier (1) by using a radiation beam, said apparatus comprising:
a determination means (7) for determining at least one of a writing power and an asymmetry of data written on said record carrier (1);
actuator means (4) for applying a predetermined radial error offset to said radiation beams with respect to a writing track of said record carrier (1); and
offset control means (7) for controlling said actuator means (4) so as to change said radial error offset in response to at least one of said determined writing power and said determined asymmetry.

2. The apparatus according to claim 1, wherein said offset control means (7) is configured to change said radial error offset during a writing operation.

3. The apparatus according to claim or 2, wherein said offset control means (7) is configured to change said radial error offset if at least one of said determined writing power and said determined asymmetry changes.

4. The apparatus according to claim 3, wherein said offset control means (7) is configured to change said radial error offset in a stepwise manner within a predetermined range of at least one of said determined writing power and said determined asymmetry, and wherein said radial error offset is changed by a predetermined first amount for every change of at least one of said determined writing power and said determined asymmetry by a respective predetermined second amount.

5. The apparatus according to claim 3 or 4, wherein said offset control means (7) is configured to keep constant said radial error offset if at least one of said determined writing power and said determined asymmetry exceeds a respective predetermined first threshold value.

6. The apparatus according to any one of claims 3 to 5, wherein said offset control means (7) is configured to keep constant said radial error offset if at least one of said determined writing power and said determined asymmetry is lower than a respective predetermined second threshold value.

7. The apparatus according to any one of the preceding claims, wherein said determination means (7) is configured to determine said asymmetry during an optimum power control procedure.

8. The apparatus according to any one of the preceding claims, wherein said record carrier (7) is an opposite track path (OTP) disc.

9. A method of writing data on a record carrier (1) by using a radiation beam, said method comprising the steps of:
determining at least one of a writing power and an asymmetry of data written on said record carrier (1); and
controlling a radial error offset, applied to said radiation beam with respect to a writing track of said record carrier (1), in response to at least one of said determined writing power and said determined asymmetry.

10. A computer program product comprising code means for producing the steps of method claim 9 when run on a computer device.
